(19) United States
(12) Patent Application Publication
(10) Pub. No.: US 2002/0054960 A1
(43) Pub. Date: May 9, 2002

(54) Method for making an optical film

(76) Inventor: Sung-Hoe Yoon, Ahnyang-shi (KR)

Correspondence Address: LONG ALDRIDGE & NORMAN LLP, Sixth Floor, Suite 600, 701 Pennsylvania Avenue, N.W., Washington, DC, 20004, US

(21) Appl. No.: 09/893,975

(22) Filed: Jun. 29, 2001

(30) Foreign Application Priority Data
Nov. 7, 2000 (KR) 2000-65714

(51) Int. Cl. B05D 5/06; B05D 3/12; B05D 1/36

(52) U.S. Cl. 427/402; 427/355

(57) ABSTRACT

The present invention discloses a method of fabricating an optical film that includes a liquid crystal layer. When forming the liquid crystal layer over a single substrate, the liquid crystal layer includes an additive, i.e., a surfactant that has both hydrophobicity and hydrophilicity. This additive is positioned on the surface of the liquid crystal layer after completing the optical film. Due to the hydrophobicity and hydrophilicity of the additive, this additive and an alignment layer that is formed on the substrate control an orientation of the liquid crystal molecules. Therefore, optical characteristics of the optical film are improved.

### CROSS REFERENCE TO RELATED APPLICATIONS

This application claims the benefit of Korean Patent Application No. 2000-65714, filed on Nov. 7, 2000, which is hereby incorporated by reference for all purposes as if fully set forth herein.

### BACKGROUND OF THE RELATED ART

1. Field of the Invention

The present invention relates to an optical film, and more particularly to a method of forming the optical film on a single substrate. Although the present invention is suitable for a wide scope of applications, it is particularly suitable for increasing optical characteristics by controlling an orientation of liquid crystal molecules when forming the optical filter such as a high brightness film, a color filter, an ultraviolet (UV) filter, an infrared (IR) filter and etc.

2. Description of Related Art

In general, liquid crystal molecules have an anisotropic characteristic and are used in a liquid crystal cell and film. The anisotropy of the liquid crystal molecules is changeable depending on the distribution of the liquid crystal molecules or the tilt angle of the liquid crystal molecules relative to a substrate of the liquid crystal cell. This characteristic is also a primary factor for changing polarization of light and affects the viewing angles of the liquid crystal cell and film. Due to this characteristic of the liquid crystal, the brightness and contrast ratio of a liquid crystal display vary in accordance with the up-and-down or left-and-right viewing angle. As a result of this, the liquid crystal display device has a shortcoming in the viewing angle.

In order to overcome the above-mentioned problems, a compensation film, which compensates the anisotropic distribution caused by the viewing angle of the liquid crystal cell, is used in the liquid crystal display device. The compensation film generally has an anisotropic distribution opposite to the liquid crystal cell such that the retardation difference of the light is eliminated.

Variation of anisotropy caused by the liquid crystal molecules arranged perpendicularly to the substrate is effectively compensated by the liquid crystal because it is difficult to compensate the retardation difference using a general anisotropic organic material. Discotic liquid crystal is mainly adopted as a typical exemplary for the compensation film. In other words, since the liquid crystal molecules in the liquid crystal cell are arranged perpendicular to or parallel with the substrate, the retardation of the light depends on the viewing angle. Thus, the discotic liquid crystal is employed as the compensation film with an orientation that enables the discotic liquid crystal layer to compensate the retardation of the light.

As mentioned before, in addition to the compensation film, a liquid crystal panel includes other optical films, for example, a linear polarizer and a cholesteric liquid crystal optical film. The optical film fabricated using the cholesteric liquid crystal has developed for increasing brightness and expands its utilization. Further, the optical film for increasing the brightness is utilized with the compensation film, in order to obtain a wide viewing angle and operate in a visible ray.

The compensation film can be fabricated by nematic or smectic liquid crystals. The tilt angle, between the major axes of those liquid crystal molecules and a line perpendicular to the plane of the compensation film, is important to control characteristics of the compensation film. Therefore, the liquid crystal is mainly used for forming the compensation film or the film for increasing brightness due to the fact that the liquid crystal molecules are arranged in vertical and horizontal directions.

As widely known, it is usual to align the liquid crystal on the substrate using an alignment layer. The alignment of the liquid crystal molecules is widely classified into a homogeneous alignment and a homeotropic alignment. Each alignment can also be sub-classified depending on the angles that have vertical and horizontal direction to the plane. These all are determined by the alignment layers, which are adjacent to the liquid crystal layer in both upper and lower sides.

However, some optical film including the compensation film or the film for increasing brightness is commonly fabricated by coating and then plasticizing the liquid crystal on a single substrate, in order to obtain optical characteristics with an economical and practical fabricating process. When utilizing the liquid crystal on a single substrate, one side of the liquid crystal layer is adjacent to this substrate and the other side of the liquid crystal layer is adjacent to the air. Therefore, the orientation of liquid crystal molecules in the surface adjacent to the substrate is defined by the alignment layer, while the liquid crystal molecules in the surface adjacent to the air have a tendency to align vertically. These vertically aligning characteristics are easily shown in the case when using the alignment layer that aligns the liquid crystal molecules homogeneously on the single substrate. Namely, the tilt angle of the liquid crystal molecule is orderly changed from the surface adjacent to the alignment layer on the single substrate to the surface adjacent to the air. As a matter of fact, this characteristic of the liquid crystal is adopted in fabricating the compensation film.

Hereinafter, an optical film including a cholesteric liquid crystal will be explained as an example.

The cholesteric liquid crystal has an aligning characteristic such that a liquid crystal molecule forms an angle with other liquid crystal molecules. By virtue of this characteristics, the liquid crystal molecules order themselves more or less spontaneously into a spiral-shaped or helical structure. The helical structure is repeated in a certain distance when the cholesteric liquid crystal is provided on the substrate. The regular distance of the helix is called pitch which is governed by a kind of and temperature of cholesteric liquid crystal.

The helical structure can be classified into left-handed and right-handed helical structures depending on the kind of liquid crystal. Such a liquid crystal having the left-handed helical structure is capable of reflecting left-handed circularly polarized light, while a liquid crystal having the right-handed helical structure reflects right-handed circularly polarized light. When the cholesteric liquid crystal layer reflects the light, a wavelength of the reflected light depends on the pitch of and birefringence of this liquid crystal. Light whose wavelength does not correspond to the pitch passes through the cholesteric liquid crystal.

As mentioned before, the cholesteric liquid crystal having a selectively reflective property has a virtue of controlling a reflection band of the light by controlling the pitch. By virtue of this property, the cholesteric liquid crystal has wide application.

The reflective efficiency of the light in the reflection band is defined by the orientation of the cholesteric liquid crystal. If the helical structure assumes such an orientation that the axis of the helix extends perpendicularly to the substrate, the maximum reflective efficiency will be obtained in the reflection wavelength band of the light. On the contrary, if the axis of the helix extends in variable directions and is distributed in wide ranges, the reflective efficiency is decreased in the reflection band of the light, thereby increasing the refraction of the light and deteriorating the characteristics of the cholesteric liquid crystal.

In such a manner, due to the characteristics of the cholesteric liquid crystal layer, the efficiency of the optical film fabricated using the single substrate is not great. Hereinafter, the structure of the optical film having a conventional cholesteric liquid crystal will be made in detail referring to FIG. 1.

FIG. 1 is a schematic perspective view illustrating an optical film including a conventional cholesteric liquid crystal on a single substrate. As shown, a substrate 31 includes an alignment film 32 that is rubbed. Thereafter, a cholesteric liquid crystal layer 33 is formed on the alignment film 32 using a coating process. When forming the liquid crystal layer 33 over the single substrate 31, the liquid crystal molecules adjacent to the substrate 31 are arranged parallel with the substrate 31, while the liquid crystal molecules adjacent to the air are arranged perpendicularly to the substrate 31. Therefore, the helical structure of the liquid crystal becomes unstable as the helix goes by the air.

In general, since the reflective wavelength and efficiency are sensitively influenced by the extent of the orientation of the cholesteric liquid crystal, the optical film having the cholesteric liquid crystal is influenced by the orientation of the liquid crystal. Namely, the optical characteristics, such as the reflective efficiency, the selective reflection wavelength band and the polarization characteristic, are affected by the extent of the liquid crystal orientation.

Therefore, if the cholesteric liquid crystal is orientated properly and uniformly, the pitch of the helix determines the reflective wavelength, and the reflectance increases in proportion to the amount of the pitch and finally arrives at a maximum. Afterward, the cholesteric liquid crystal maintains an even reflectance.

On the contrary, if the cholesteric liquid crystal has an unstable helical structure, as previously mentioned, the reflection wavelength band broadens due to the various pitch, and the reflectance decreases due to a lack of pitch in each reflective wavelength.

### SUMMARY OF THE INVENTION

Accordingly, the present invention is directed to a method of forming an optical film having a liquid crystal, which substantially obviates one or more of problems due to limitations and disadvantages of the related art.

An object of the present invention is to provide a method of fabricating an optical film using a liquid crystal that includes an additive, which improves optical characteristics of the optical film.

Additional features and advantages of the invention will be set forth in the description which follows and in part will be apparent from the description, or may be learned by practice of the invention. The objectives and other advantages of the invention will be realized and attained by the structure particularly pointed out in the written description and claims hereof as well as the appended drawings.

In order to achieve the objects, a method of fabricating an optical film includes preparing a substrate; forming an alignment layer on the substrate; rubbing the alignment layer; and forming a liquid crystal layer that includes an additive on the alignment layer.

Forming the liquid crystal layer comprises coating a liquid crystal including the additive and plasticizing the liquid crystal on the substrate. Further, plasticizing the liquid crystal including the additive on the substrate uses one of ultraviolet rays or heat.

The additive is a surfactant and has both a hydrophobic group and a hydrophilic group. Also, the additive includes dimenthylsiloxane as a major component.

The above-mentioned liquid crystal layer is a cholesteric liquid crystal layer, a nematic liquid crystal layer or a smectic liquid crystal layer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of the specification, illustrate embodiments of the invention and together with the description serve to explain the principles of the invention.

In the drawings:

FIG. 1 is a schematic perspective view illustrating an optical film including a conventional cholesteric liquid crystal on a single substrate;

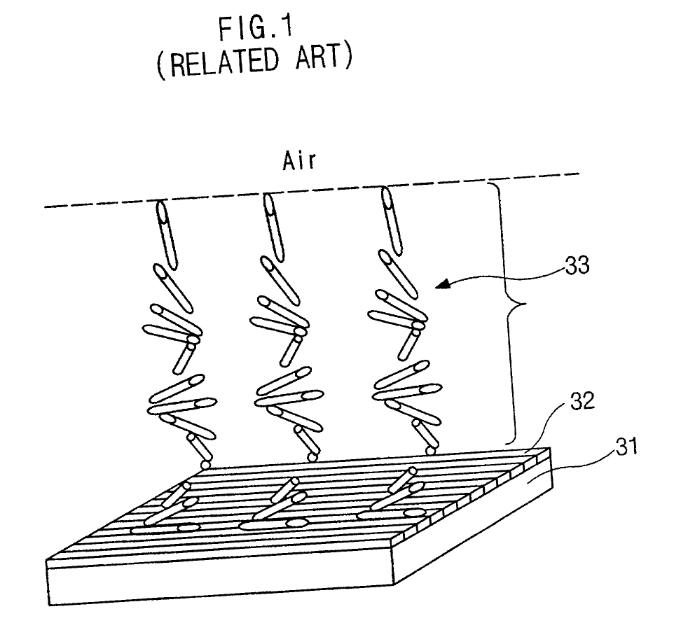

FIG. 2 is a schematic perspective view illustrating an optical film including a cholesteric liquid crystal with an additive according to the present invention; and

FIG. 3 is a schematic perspective view illustrating an optical film including a nematic (or smectic) liquid crystal with an additive according to the present invention.

### DETAILED DESCRIPTION OF PREFERRED EMBODIMENTS

Reference will now be made in detail to the preferred embodiments of the invention, examples of which are illustrated in the accompanying drawings. Wherever possible, the same reference number will be used throughout the drawings to refer to the same or like parts.

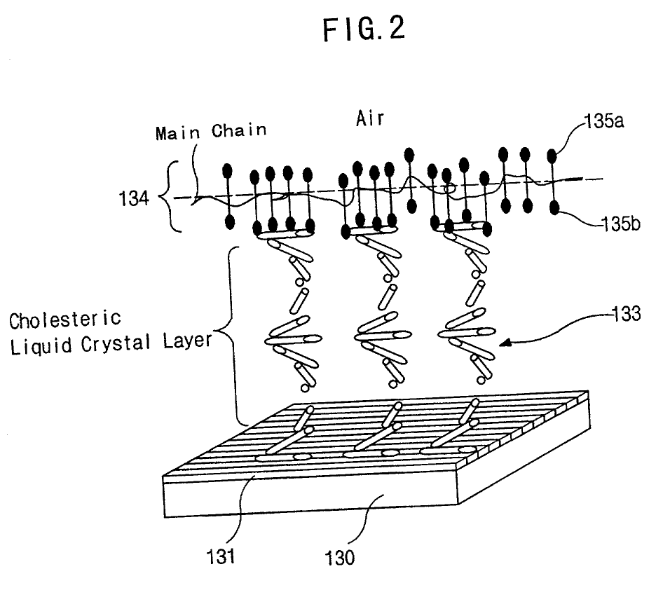

FIG. 2 is a schematic perspective view illustrating an optical film including a cholesteric liquid crystal with an additive according to the present invention. As shown, a single substrate 130 includes an alignment layer 131 on one surface, and a cholesteric liquid crystal layer 133 having an additive 134 is formed on the alignment layer 131.

In the present invention, when forming a liquid crystal layer on the alignment layer, a liquid crystal having an additive or a solvent thereof is aligned and orientated by applying coating method such as spin coating, knife coating, bar coating or gravure coating. Thereafter, a liquid crystal film is fabricated using ultraviolet rays or heat.

Still referring to FIG. 2, the additive 134 is an amphiphilic material. Namely, the additive 134 is a kind of surfactant including both a hydrophobic group 135a and a hydrophilic group 135b. The hydrophobic group 135a tends to be adjacent to the air due to hydrophobicity, while the hydrophilic group 135b tends to contact liquid crystal layer due to its hydrophilicity. As shown in FIG. 2, not only does the additive 134 function as a leveling agent, but it also diminishes surface tension, i.e., the additive 134 removes spin pattern of the liquid crystal molecules in the surface of the cholesteric liquid crystal layer 133. In the present invention, the additive 134 includes dimethylsiloxane as a main component.

Therefore as above, when forming the liquid crystal layer 133 having the additive 134 on the substrate 130, the hydrophobic group 135a of the additive 134 is spontaneously disposed in the interface between the air and the liquid crystal layer 133 in order to enlarge a contact area toward the air. From this manner, the hydrophilic group 135b of the additive 134 prevents the cholesteric liquid crystal molecules disposed in the surface from being arranged perpendicularly to the substrate 130 by a way of the interaction between the hydrophilic group 135b and the cholesteric liquid crystal molecules. As a result, the orientation of the cholesteric liquid crystal layer 133, for example, the tilt angle, is controlled.

The above-mentioned cholesteric liquid crystal layer 133, which has the additive 134 in its surface, is plasticized using the previously mentioned optical hardening or thermal hardening process. However, the additive 134 does not show reactions with the cholesteric liquid crystal during the hardening process. As the time goes on, the additive 134 can disappear after completing the optical film. The orientation of the plasticized cholesteric liquid crystal layer 133, however, is not influenced by the additive loss because of the cross-linking reaction between the cholesteric liquid crystal molecules.

In order to evaluate effects to the optical characteristic of the liquid crystal film in which the orientation of the liquid crystal molecules is controlled by the additive, the cholesteric liquid crystal films with and without the additive are fabricated and then tested to show UV-VIS spectrums (ultraviolet-visible rays spectrums). After the test, the reflection wavelength band and the reflectance are compared between the cholesteric liquid crystal films with and without the additive.

The cholesteric liquid crystal film without the additive has a band width of 70 to 100 nm in the central reflective wavelengths of 540 nm (green) and 640 nm (red). Further, the reflectance of the cholesteric liquid crystal film that does not include the additive is 55 to 80%.

The cholesteric liquid crystal film with the additive has a band width of 60 to 80 nm in the above-mentioned central reflective wavelengths (540 nm and 640 nm). The reflectance of the cholesteric liquid crystal including the additive is 80 to 95%. As a result, the cholesteric liquid crystal with the additive has better selective reflection and reflective efficiency than that without the additive.

Accordingly, the high color purity is embodied in the liquid crystal display device adopting the above-mentioned inventive optical film that includes the cholesteric liquid crystal with the additive.

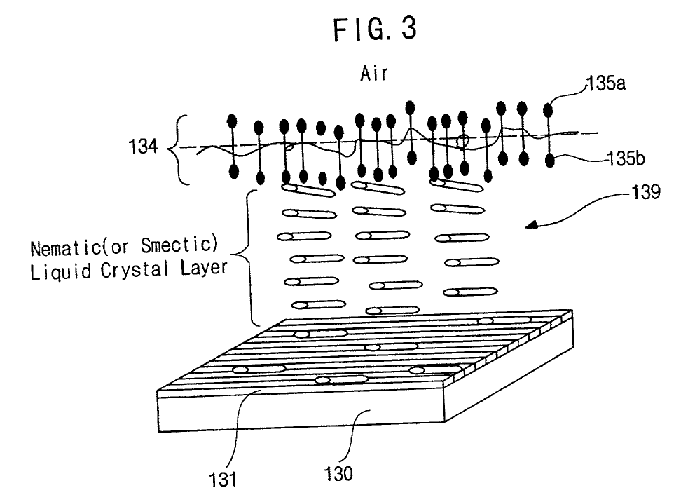

Furthermore, the nematic or smectic liquid crystal can be substituted for the cholesteric liquid crystal. Now, the optical film including the nematic liquid crystal, as an example, will be explained referring to FIG. 3.

FIG. 3 is a schematic perspective view illustrating an optical film including a nematic (or smectic) liquid crystal with an addition according to the present invention. Although the optical film of FIG. 3 is similar to that of FIG. 2, the optical film includes a nematic (or smectic) liquid crystal layer 139 instead of the cholesteric liquid crystal layer 133 of FIG. 2.

As shown in FIG. 3, due to the additive 134, the nematic liquid crystal molecules in the liquid crystal layer 139 adjacent to the air are not arranged vertically, but arranged parallel with the substrate 130, like the above-mentioned optical film having the cholesteric liquid crystal. Further, since the tilt angle of the nematic liquid crystal molecules can be controlled into the designed angle, this optical film is suitable for the liquid crystal panel that needs a wide viewing angle. Also, the smectic liquid crystal can be used instead of the nematic liquid crystal.

As described before, the tilt angles of the liquid crystal molecules are adjusted by the additive and alignment layer throughout the liquid crystal layer, i.e., from the bottom to top. Many kinds of the compensation films can be fabricated according to the present invention.

As described herein, the present invention has the following advantages.

First, the optical characteristics of the liquid crystal film are improved without additional manufacturing processes due to the fact that the additive is included in the liquid crystal layer.

Second, the surface of the liquid crystal layer has an improved uniformity due to the fact that the additive in the liquid crystal layer decreases the surface tension.

It will be apparent to those skilled in the art that various modification and variations can be made in the manufacturing method of the present invention without departing from the spirit or scope of the invention. Thus, it is intended that the present invention cover the modifications and variations of this invention provided they come within the scope of the appended claims and their equivalents.

What is claimed is:

1. A method of fabricating an optical film, comprising:
preparing a substrate;
forming an alignment layer on the substrate;
rubbing the alignment layer; and
forming a liquid crystal layer on the alignment layer that includes an additive.

2. The method according to claim 1, wherein forming the liquid crystal layer comprises coating a liquid crystal including the additive and plasticizing the liquid crystal on the substrate.

3. The method according to claim 2, wherein plasticizing the liquid crystal including the additive on the substrate uses one of ultraviolet rays or heat.

4. The method according to claim 1, wherein the additive is a surfactant.

5. The method according to claim 4, wherein the additive has both a hydrophobic group and a hydrophilic group.

6. The method according to claim 5, wherein the additive includes dimenthylsiloxane.

7. The method according to claim 1, wherein the liquid crystal layer is a cholesteric liquid crystal layer.

8. The method according to claim 1, wherein the liquid crystal layer is a nematic liquid crystal layer.

9. The method according to claim 1, wherein the liquid crystal layer is a smectic liquid crystal layer.
